(19) United States
(12) Patent Application Publication
(10) Pub. No.: US 2007/0217608 A1
(43) Pub. Date: Sep. 20, 2007

(54) Data scramble/descramble technique for improving data security within semiconductor device

(75) Inventor: Shinya Shimasaki, Kanagawa (JP)

Correspondence Address: FOLEY AND LARDNER LLP;SUITE 500, 3000 K STREET NW, WASHINGTON, DC, 20007, US

(73) Assignee: NEC Electronics Corporation

(21) Appl. No.: 11/723,206

(22) Filed: Mar. 16, 2007

(30) Foreign Application Priority Data
Mar. 17, 2006 (JP) 2006-074875

(51) Int. Cl. H04N 7/167

(52) U.S. Cl. 380/228

(57) ABSTRACT

A data scramble method includes: preparing a seed value in a storage device provided outside of a CPU integrated within a semiconductor device; performing a key generation process to generate a scramble key from the seed value; and performing a scramble process on target data by using the key data. The key generation process and the scramble process are performed within the CPU or a scramble circuit connected with the CPU through a bus.

### BACKGROUND OF THE INVENTION

1. Field of the Invention

The present invention relates to data protection within a semiconductor device, in particular, to data scramble/descramble for improving security of a secret key and/or a random number used for generating a secret key.

2. Description of the Related Art

In recent years, semiconductor devices are used for applications in which data security is important, such as user authentication and data encryption. In such applications, protection of security-related data, including secret keys and random numbers used for generating secret keys within encryption circuits, is of much significance.

Disadvantageously, various attacks are known for physically intercepting security-related data. One known attack technique is to monitor signals developed on external terminals of the semiconductor device during an authentication operation by using a monitoring apparatus, such as a logic analyzer.

The bus probing is one of the most alarming data attack techniques. The bus probing is typically achieved by removing the outer packaging, including the mold resin, to thereby expose the semiconductor chip, and then probing the internal bus with monitor probes of a monitor apparatus, such as an oscilloscope. The bus probing allows directly intercepting secret data from the internal bus.

The data scrambling is one known approach for avoiding the bus probing. In a semiconductor device adapted to data scrambling, secret data is scrambled with a scramble key to hide the original. The original data is obtained from data descrambling by using a descramble key. The same key may be used for scrambling and descrambling.

One of the widely-used data scrambling algorithms is the XOR algorithm. In the XOR algorithm, secret data is scrambled through XOR operation of the secret data and the scramble key. Advantageously, The XOR algorithm only requires relatively simple calculations with reduced hardware resources. Although may be effective for hiding the original data after the scramble key is intercepted by bus probing, other complicated scrambling algorithms undesirably requires increased hardware resources, and this does not satisfy the needs in low-end applications, such as IC cards and portable terminals, which requires size reduction.

In using a simple scramble algorithm, such as the XOR algorithm, improving the security of the scramble key is of much importance. Japanese Laid-Open Patent Application No. JP-A Heisei 6-342257 discloses a technique which generates a scramble key used for scramble/descramble with improved randomness by using four linear feedback shift registers (hereinafter, abbreviated as “LFSR”) and a non-linear transformation unit performing non-linear transformation on the outputs of the LFSRs. Japanese Laid-Open Patent Application No. JP-A Heisei 8-307411 discloses a similar technique, which further improves the randomness of the scramble key in a scramble key generation circuit.

Japanese Laid-Open Patent Application No. JP-A Heisei 7-28406 discloses a technique for improving the security of the scramble key, in which a scramble key is incorporated within an application program, and the scramble key is loaded together with the application program onto the main memory.

However, these conventional techniques do not sufficiently defend the scramble key from the bus probing attack.

### SUMMARY OF THE INVENTION

In an aspect of the present invention, a data scramble method includes: preparing a seed value in a storage device provided outside of a CPU integrated within a semiconductor device; performing a key generation process to generate a scramble key from the seed value; and performing a scramble process on target data by using the key data. The key generation process and the scramble process are performed within the CPU or a scramble circuit connected with the CPU through a bus.

The method according to the present invention effectively defends the scramble key from the bus probing, since the method avoids the scramble key being transferred over a peripheral bus, which is the target of the bus probing.

In one embodiment, the scramble key is stored inside of the CPU, specifically, in a general purpose register within the CPU, and the target data to be protected is scrambled with the key data by using the general purpose register. In another embodiment, a scramble circuit is used so as to avoid the key data being transferred over the peripheral bus instead of using the general purpose register. This technique, based on the same technical idea as the above-described technique, is also effective for preventing the bus probing.

In another aspect of the present invention, a data descramble method includes: preparing a seed value onto a storage provided outside of a CPU integrated within a semiconductor device; performing a key generation process to generate a descramble key from the seed value; and performing a descramble process on target data by using the descramble key. The key generation process and the descramble process are performed within the CPU or a descramble circuit connected with the CPU through a bus.

### BRIEF DESCRIPTION OF THE DRAWINGS

The above and other advantages and features of the present invention will be more apparent from the following description taken in conjunction with the accompanied drawings, in which:

FIG. 1 is a block diagram of a semiconductor device in a first embodiment of the present invention;

FIG. 2 is a flowchart of the operation of the semiconductor device in a data scramble operation in the first embodiment;

FIG. 3 is a flowchart of the operation of the semiconductor device in a data descramble operation in the first embodiment;

FIGS. 4 to 6 are schematic diagrams illustrating a procedure of key generation;

FIG. 7 is a schematic diagram illustrating a procedure of scrambling desired data with the generated scramble key; and

FIG. 8 is a block diagram of a semiconductor device in a second embodiment of the present invention.

### DESCRIPTION OF THE PREFERRED EMBODIMENTS

The invention will be now described herein with reference to illustrative embodiments. Those skilled in the art would recognize that many alternative embodiments can be accomplished using the teachings of the present invention and that the invention is not limited to the embodiments illustrated for explanatory purposed.

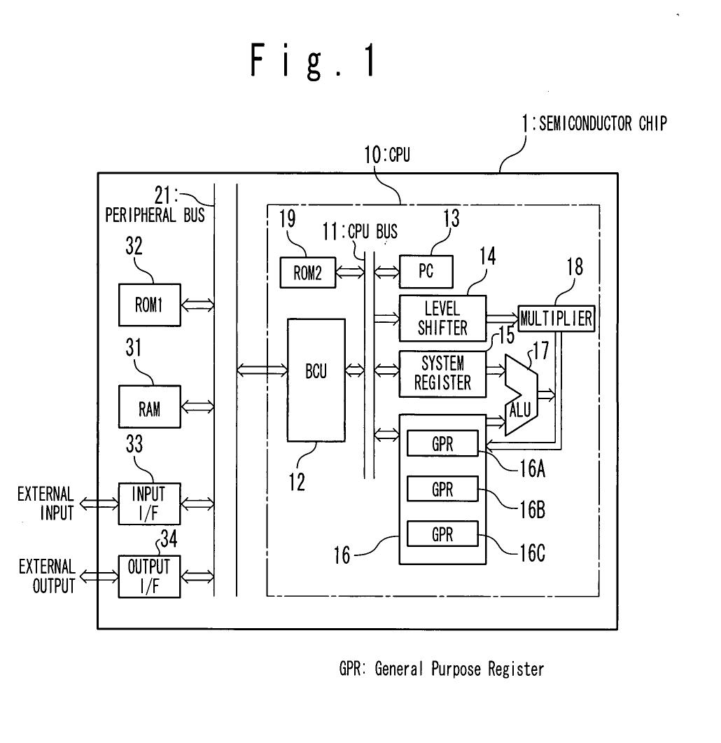

In a first embodiment, as shown in FIG. 1, a semiconductor device 1 is provided with a CPU 10, a RAM 31, a first ROM 32, an input I/F (interface) 33, an output I/F 34, and a peripheral bus 21, which are monolithically integrated within a single semiconductor chip. It should be noted that the peripheral bus 21 collectively denotes a set of buses, including an address bus and a data bus. The peripheral bus 21 transfers data and addresses among the CPU 10, the RAM 31, the first ROM 32, the input I/F 33, the output I/F 34 and other circuits. The input I/F 33 and the output I/F 34 provide data access from and to an external device through external terminals (not shown).

The CPU 10 incorporates therein a CPU bus 11, a BCU (bus control unit) 12, a program counter 13, a level shifter 14, a set of system registers 15 (one shown), general purpose registers 16, an ALU (arithmetic logic unit) 17, a multiplier 18, a second ROM 19. The BCU 12 controls data transfer between inside and outside of the CPU 10 through the peripheral bus 21 (such as, data transfer between the internal circuits within the CPU 10 and the RAM 31, the first ROM 1, and the like), and also controls data transfer within the CPU 10 through the CPU bus 11. The system registers 15 collectively denote dedicated registers for specific system functions, such as, input/output registers, and accumulation registers. The general purpose registers 16 collectively denote registers allowed to use various purposes. For distinction, three of general purpose registers 16 may be denoted by the numerals 16A, 16B, 16C, hereinafter. The second ROM 19 stores therein a program for implementing scramble/descramble processes by using the general purpose registers 16 within the CPU 10.

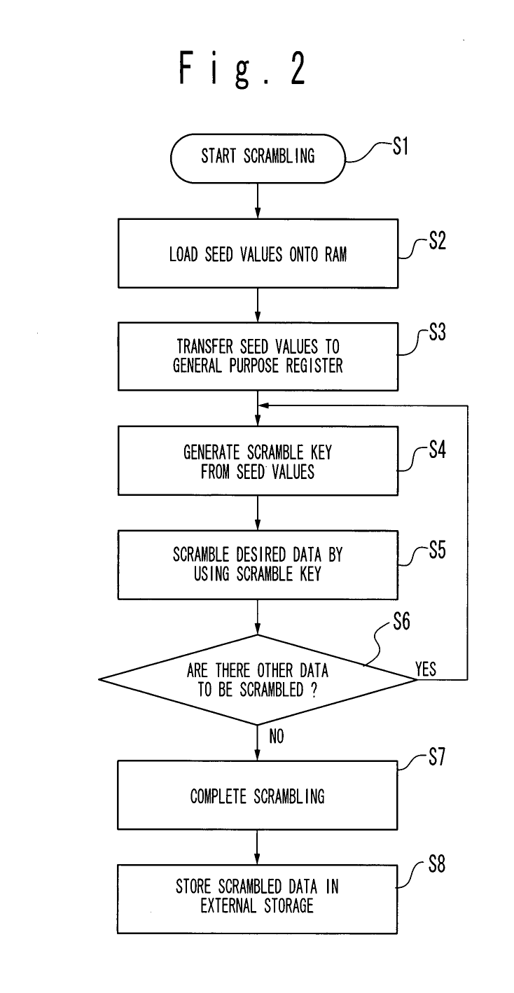

FIG. 2 is a flowchart illustrating the operation of the semiconductor device in the first embodiment in data scramble. The data scramble operation is mainly implemented within the CPU 10 by using the general purpose registers 16. Although the data scramble operation is actually implemented by using other units including the system registers 15, the ALU 17, and the program counter 13, the use of these units are well-known in the art, and not described in detail; the following description is mainly directed to the way of the use of the general purpose registers 16.

In response to a scramble start command fed to the CPU 10, as shown in FIG. 2, the data scramble operation is initiated at Step S1, and seed values used for generating a scramble key are loaded onto the RAM 31 at Step S2. In one embodiment, the seed values are externally provided for the RAM 31 through the input I/F 33. In an alternative embodiment, the seed values may be programmed in the first ROM 32 in the manufacture process, and the seed values are transferred from the first ROM 32 to the RAM 31.

This is followed by transferring the seed values stored in the RAM 31 to one of the general purpose registers 16 through the BCU 12 of the CPU 10 at Step S3. More specifically, the general purpose register 16A is assigned to key generation, and the seed values are loaded onto the general purpose register 16A. The general purpose register 16A may be referred to as the key generation register 16A, hereinafter. As described later, the general purpose register 16B is assigned to store data to be scrambled or descrambled.

Subsequently, the CPU 10 generates a scramble key by using the general purpose register 16A and other resources within the CPU 10. A specific example of the generation of the scramble key is described later. When the scramble processes are repeatedly implemented, a scramble key is generated from the seed values at the first round, and a scramble key is generated at the second round from the scramble key generated at the first round. In the same way, a scramble key is generated at the third round from the scramble key generated at the second round, and the same goes for the following round(s).

At Step S5, the CPU 10 then scrambles desired data by using the scramble key. The desired data to be scrambled may be, for example, an operation result of the CPU 10 stored in the general purpose register 16B. A specific example of the scrambling process at Step S5 will be given later.

This is followed by checking whether there are other data to be scrambled at Step S6. If so, the procedure goes back to Step S4, and the scramble process is implemented again. If not so, the scramble operation is completed at Step S7. The scrambled data are then stored in the general purpose register 16B. At Step S8, the scrambled data stored in the general purpose register 16B are exported to a storage device outside the CPU 10, such as the RAM 31, through the peripheral bus 21. This completes the data scramble procedure.

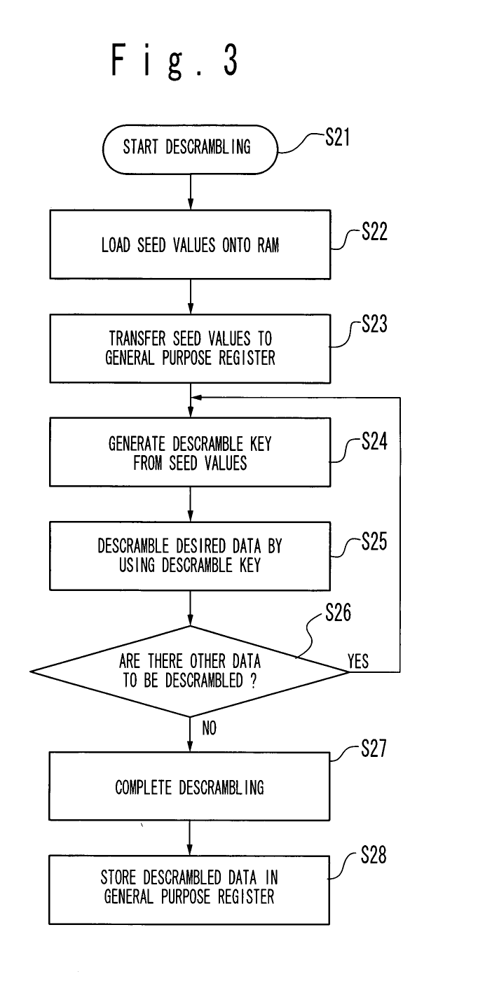

FIG. 3 is a flowchart illustrating the data descramble operation in which the scrambled data are descrambled. The data descramble operation is almost similar to the scramble operation. The data descramble operation is initiated at Step S21, and the seed values are prepared in the RAM 31 at Step S22. The seed values are then loaded onto the general purpose register 16A at Step S23, and a descramble key is then generated from the seed values at Step S24. In this embodiment, the same key is used as the scramble key and the descramble key. After the generation of the descramble key, desired data are descrambled by using the descramble key at Step S25. The desired data to be descrambled are previously generated by scrambling, and stored in general purpose register 16B.

This is followed by checking whether there is another data to be descrambled at Step S26. If so, the procedure goes back to Step S24, and the descramble operation is implemented again. If not so, the data descramble operation is completed at Step S27. The descrambled data are then stored in the general purpose register 16B to complete the processes related to the descramble operation at Step S28.

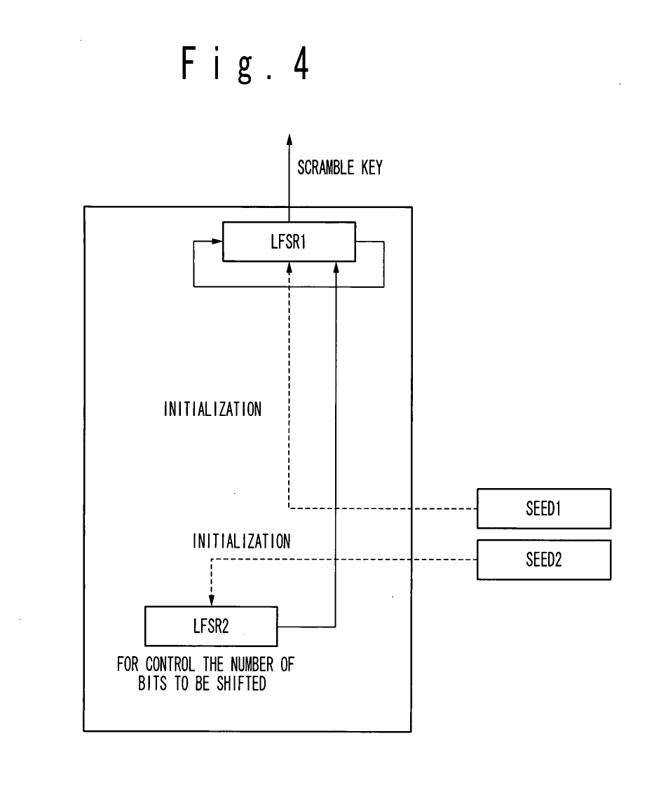

FIGS. 4 to 7 illustratively explain the key generation and the scramble operation of FIG. 2. FIG. 4 is a schematic diagram explaining the scramble key generation in the first embodiment. As described above, the scramble key is generated by using the general purpose register 16A and other resources within the CPU 10, such as the ALU 17. The general purpose register 16A incorporates a pair of LFSRs (linear feedback shift registers), which are referred to as LFSR1 and LFSR2, hereinafter. The LFSR1 contains a value used as the scramble key as it is, while the LFSR2 is used to control the shift operation of the LFSR1. In this embodiment, the scramble key is generated from two seed values, and one of the seed values is initially loaded onto the LFSR1, while the other is initially loaded onto the LFSR2. In the following the seed values loaded onto the LFSR1 and LFSR2 are referred to as the seed values SEED1 and SEED2, respectively. The number of the seed values used for generating the scramble key is not limited to two. Instead, three seed values may be used for generating the scramble key. In this case, three LFSRs are used to generating the scramble key accordingly.

In order to help the understanding, a specific example is given in the following explanation, in which the seed value SEED2 is “0x2” and the seed value SEED1 is “0x2ECA”. It should be noted that the prefixes “0x” indicate that the following values “2” and “2ECA” are hexadecimal numbers.

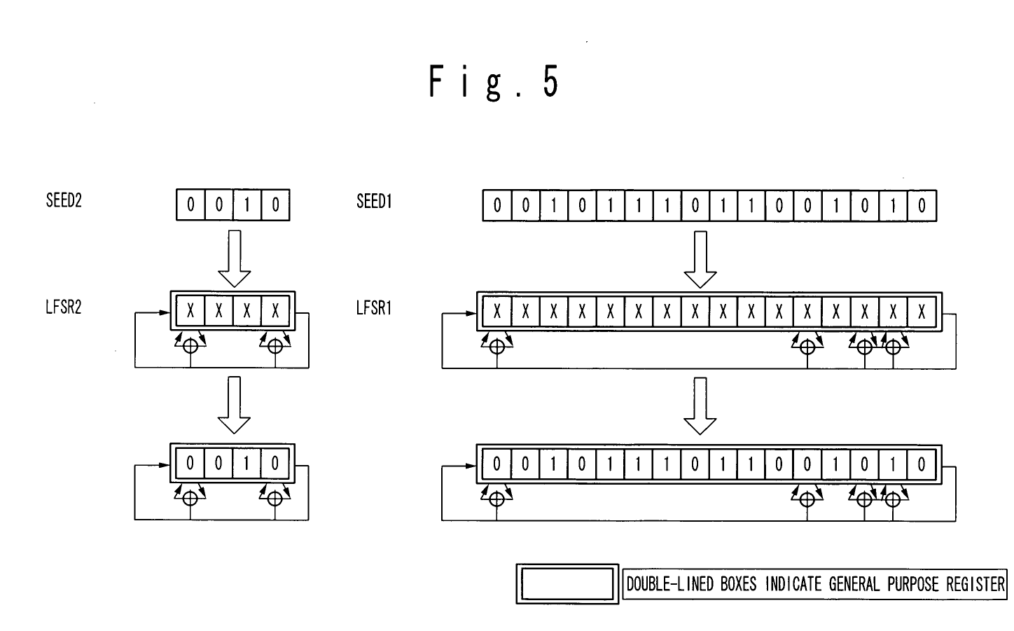

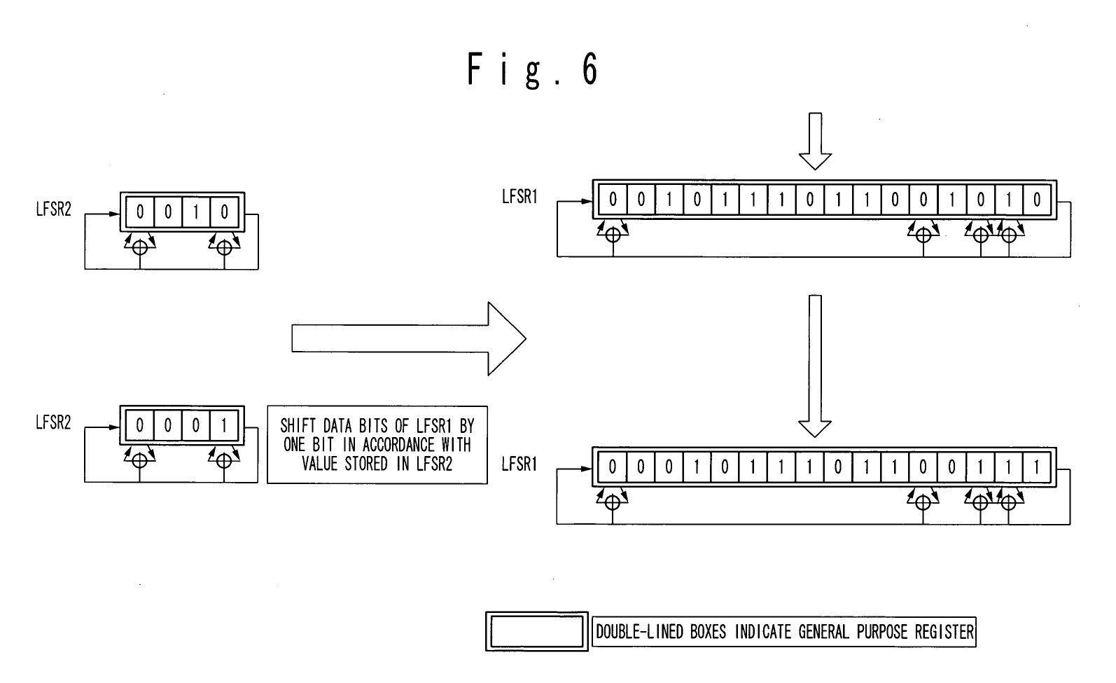

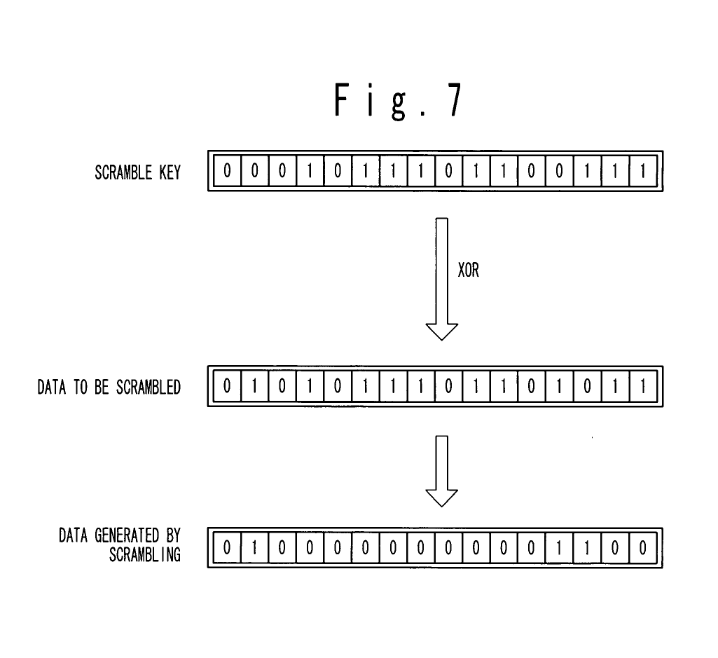

As described above, the seed values are loaded onto the general purpose registers 16A at Step S3 (See FIG. 2). In detail, the seed value SEED1 “0x2ECA” is set to the LFSR1, and the seed value “0x2” is set to the LFSR2, as shown in FIG. 5. The double-lined boxes in FIG. 5 (as well as FIGS. 6 and 7) indicate that the values in the boxes are stored in the general purpose register 16A. In this example, the general purpose register 16A is designed to store 20 or more data bits, since the LFSR2 stores four bits and the LFSR1 stores 16 bits. The LFSR1 and LFSR2 may be incorporated within different general purpose registers. For example, the LFSR1 may be incorporated within the general purpose register 16A, while the LFSR2 may be incorporated within the general purpose register 16C.

FIGS. 6 and 7 illustrate specific data transitions in the scramble operation in the LFSR1 and the LFSR2. Firstly, the LFSR2 is subjected to one-bit right shift; the result developed on the LFSR2 is “0x1”. The LFSR1 is then subjected to a right shift operation in response to the value of the LFSR2. The number of bits of the right shift of the LFSR1 is identical to the value of the LFSR2. The result of the right shift developed on the LFSR1 is “0x1767”. The result of the right shift is defined as the scramble key. Finally, desired data are scrambled by implementing an XOR operation of the desired data and the scramble key. The result of the scramble process is “0x400C” as shown in FIG. 7. The scrambled data (that is, the result of the scramble operation) are exported to a storage device outside of the CPU 10, such as the RAM 31, from the general purpose register 16B through the CPU bus 11 and the peripheral bus 21. The scrambled data may be outputted to an external device through the output I/F 34, if necessary, or used only within the semiconductor chip 1 without externally outputting the scrambled data. It should be noted that the desired data to be scrambled may be an operation result of the CPU 10 stored in the general purpose register 16B, as described in the relation of Step S5 in FIG. 2.

In one embodiment, the descramble operation may be implemented in the same way as the scramble operation. The descramble key may be generated in the same manner as the scramble key. When the XOR operation is used for the scramble operation, the XOR operation is also used for the descramble operation. The program for implementing the scramble and descramble processes, both involving the XOR operation, is programmed in the second ROM 19 in the manufacture process.

As thus described, the scramble key and descramble key are generated by using the general purpose registers 16 within the CPU 10, and the scramble and descramble processes are implemented only within the CPU 10 by using the scramble key and descramble key. Such operation effectively avoids the bus probing. The physical location of the CPU bus 11 is hard to be determined by a malicious party, especially when the CPU 10 is designed by using an automated layout technique. Additionally, the physical locations of the general purpose registers 16, which are use to store the scramble and descramble keys, are also hard to be determined. Such semiconductor device architecture substantially eliminates the possibility of successfully achieving bus probing, improving the data security without using neither a special encrypt process nor a dedicated circuit.

Although the XOR operation is used for both of the scramble and descramble processes in the first embodiment, other scramble/descramble algorithms may be used.

As described above, the scrambled data may be used only within the semiconductor chip 1 without externally outputting the scrambled data. In one embodiment, a random number table generated by RNG (random number generator) software is scrambled and then loaded onto the RAM 31, and the scrambled random number table on the RAM 31 is descrambled by a DSA (Digital Signature Algorithm) before using the random number table. In this case, the scrambled random number table is not externally outputted through the output I/F 34.

As also described above, the program for implementing the scramble and descramble operations is programmed in the second ROM 19 in the manufacture process in the first embodiment, and this is preferable for the protection of the program. Alternatively, the program for implementing the scramble and descramble operations may be programmed in the first ROM 32, and loaded onto the CPU 10. In this case, the CPU 10 does not require the second ROM 19.

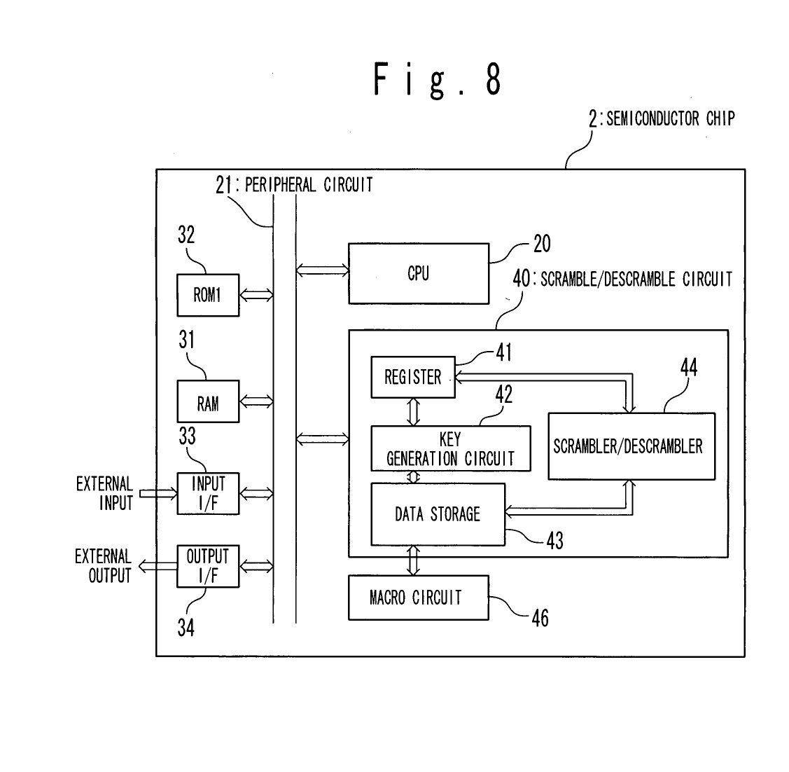

FIG. 8 is a block diagram illustrating a semiconductor device 2 in a second embodiment of the present invention. In the second embodiment, the semiconductor device is designed to deal with a problem of the limitation of the amount of data processable by the general purpose registers within the CPU. It should be noted that the semiconductor device 2 is designed under the similar technical idea of the first embodiment, while incorporating a scramble/descramble circuit dedicated for the scramble/descramble operation to reduce the frequency of the use of the general purpose registers within the CPU.

Specifically, the semiconductor device in the second embodiment is provided with a semiconductor chip 2 integrating therein a scramble/descramble circuit 40. The scramble/descramble circuit 40 is configured to generate and store the scramble and descramble keys, and also to implement data scrambling and descrambling.

The semiconductor chip 2 is designed similarly to the semiconductor chip 1 shown in FIG. 1. It should be noted that the same elements are denoted by the same numerals in FIG. 8, and no detailed description thereof is given in the following. The CPU 20 in the semiconductor chip 2 is structured similarly to the CPU 10 in the semiconductor chip 1, except for that the CPU 20 is neither adapted to generate the scramble and descrambled keys, nor provided with the second ROM 19 for storing the program for the scramble/descramble operation.

The scramble/descramble circuit 40 incorporates therein a register 41, a key generator 42, a data storage unit 43 and a scrambler/descrambler unit 44. The scrambler/descrambler unit 44 is designed to scramble and descramble desired data, and the data storage unit 43 is used to store the scrambled and descrambled data. The semiconductor chip 2 further includes a hard macro circuit 46 designed to perform specific data processing, and the processing results generated by the macro circuit 46 are inputted to the data storage unit 43. The data storage unit 43 may include a set of registers.

The following is a description of the operation of the semiconductor device in the second embodiment, including the comparison of the first and second embodiments. In the first embodiment, the scramble and descramble operations are achieved by software implementation which involves using the general purpose registers 16 within the CPU 10, while the scramble and descramble operations are achieved by hardware, specifically, the scramble/descramble circuit 40. In response to a command received from the CPU 20, the key generator 42 generates the scramble and descramble keys from seed values received from the RAM 31 through the peripheral bus 21. The generated scramble and descramble keys are stored in the register 41. The scrambler/descrambler unit 44 implements scramble and descramble processes by using the scramble and descramble keys stored in the register 41. In one embodiment, data to be scrambled include the operation results of the macro circuit 46 and stored in the data storage unit 43. Instead, the data to be scrambled may include data generated by software. The key generator 42 and the scrambler/descrambler unit 44 are structured as hardware, incorporating an electronic circuitry, as is known in the art.

In one embodiment, the key generator 42 is configured to implement the operation shown in FIGS. 4 to 7, incorporating a pair of LFSRs: the LFSR1 and LFSR2. The register value of the LFSR1 is used as the scramble/descramble data, and the shift operation of the LFSR1 is controlled so that the number of bits of the shift of the LFSR1 is identical to the value stored in the LFSR2. The transistor level structure of the LFSR is well-known in the art and the detailed description of the LFSR1 and LFSR2 is not given. In an alternative embodiment, the key generator 42 may include three or more LFSRs.

As thus described, the use of the scramble/descramble circuit 40 effectively reduces the frequency of the use of the general purpose registers 16, thereby enhancing the operation speed.

It is apparent that the present invention is not limited to the above-described embodiments, which may be modified and changed without departing from the scope of the invention. It should be especially noted that circuits provided outside the CPU 10 (or 20), including the RAM 31 and the first ROM 32, may be integrated within a semiconductor chip separated from the CPU 10 (or 20), because the scramble/descramble key is not transferred over the peripheral bus 21, which is provided outside the CPU 10 (or 20).

What is claimed is:

1. A data scramble method comprising:
preparing a seed value onto a storage provided outside of a CPU integrated within a semiconductor device;
performing a key generation process to generate a scramble key from said seed value; and
performing a scramble process on target data by using said key data,
wherein said key generation process and said scramble process are performed within said CPU or a scramble circuit connected with said CPU through a bus.

2. The data scramble method according to claim 1, wherein said key generation is performed by using a general purpose register within said CPU.

3. The data scramble method according to claim 1, wherein said scramble process is performed by using a general purpose register within said CPU.

4. A data descramble method comprising:
preparing a seed value onto a storage provided outside of a CPU integrated within a semiconductor device;
performing a key generation process to generate a descramble key from said seed value; and
performing a descramble process on target data by using said key data,
wherein said key generation process and said descramble process are performed within said CPU or a descramble circuit connected with said CPU through a bus.

5. A semiconductor device comprising:
a CPU including a general purpose register; and
a storage unit provided outside of said CPU,
wherein said storage unit receives and stores a seed value therein, and
wherein said CPU is configured to generate a scramble key from said seed value received from said storage unit by using said general purpose register, and to perform a scramble process on desired data by using said scramble key.

6. The semiconductor device according to claim 5, wherein said CPU further includes a ROM storing a program for performing said scramble process.

7. A semiconductor device comprising:
a CPU including a general purpose register; and
a storage unit provided outside of said CPU,
wherein said storage unit receives and stores a seed value therein, and
wherein said CPU is configured to generate a descramble key from said seed value received from said storage unit by using said general purpose register, and to perform a descramble process on desired data by using said descramble key.
